(19) United States
(12) Patent Application Publication
(10) Pub. No.: US 2017/0083624 A1
(43) Pub. Date: Mar. 23, 2017

(54) CONTEXTUAL CURATED CONTENT SEQUENCE MANAGEMENT

(71) Applicant: Altair Engineering, Inc., Troy, MI (US)

(72) Inventor: James Scapa, West Bloomfield, MI (US)

(21) Appl. No.: 14/862,229

(22) Filed: Sep. 23, 2015

(51) Int. Cl. G06F 17/30; H04L 12/58

(52) U.S. Cl. CPC G06F 17/30867; H04L 51/08; H04L 51/16; G06F 17/3005

(57) ABSTRACT

A method and apparatus for contextual curated content sequence management are disclosed. Contextual curated content sequence management may include receiving a request for a sequence of content, wherein the request for the sequence of content includes a context indicator identifying a context, a curator indicator identifying a content curator, and a user indicator identifying a user, generating, by a processor in response to instructions stored on a non-transitory computer readable medium, the sequence of content. Generating the sequence of content may include identifying a plurality of content objects, and including content objects from the plurality of content objects in the sequence of content based on the context and the content curator. Contextual curated content sequence management may include transmitting at least one content object from the sequence of content for presentation to the user.

### TECHNICAL FIELD

The present disclosure relates to systems and methods of accessing digital content.

### BACKGROUND OF THE DISCLOSURE

Digital content such as computer software products, video games, music, and any other media capable of being embodied in digital format may be sold or licensed to an end user customer. Accordingly, it may be desirable to provide contextual curated content sequence management, which may include contextual curated content sequence management under unit-based licensing.

### SUMMARY OF THE DISCLOSURE

Disclosed herein are aspects, features, elements, implementations, and embodiments of contextual curated content sequence management.

In an embodiment, a method of accessing content using contextual curated content sequence management is disclosed. Accessing content using contextual curated content sequence management may include receiving a request for a sequence of content, wherein the request for the sequence of content includes a context indicator identifying a context, a curator indicator identifying a content curator, and a user indicator identifying a user, and generating, by a processor in response to instructions stored on a non-transitory computer readable medium, the sequence of content. Generating the sequence of content may include identifying a plurality of content objects, and including content objects from the plurality of content objects in the sequence of content based on the context and the content curator. Accessing content using contextual curated content sequence management may include transmitting at least one content object from the sequence of content for presentation to the user.

In another embodiment, a method of accessing content using contextual curated content sequence management is disclosed. Accessing content using contextual curated content sequence management may include receiving a request for a sequence of content, wherein the request for the sequence of content includes a context indicator identifying a context, a curator indicator identifying a content curator, and a user indicator identifying a user, and generating, by a processor in response to instructions stored on a non-transitory computer readable medium, the sequence of content. Generating the sequence of content may include identifying a plurality of content objects, identifying a plurality of curated content objects from the plurality of content objects, wherein each content object from the plurality of curated content objects is associated with a positive evaluation of the respective content object by the content curator for the context, and including content objects from the plurality of curated content objects in the sequence of content. Accessing content using contextual curated content sequence management may include transmitting at least one content object from the sequence of content for presentation to the user.

In another embodiment, a method of accessing content using contextual curated content sequence management is disclosed. Accessing content using contextual curated content sequence management may include receiving a content evaluation message, the content evaluation message including a content object indicator identifying a first content object, a user indicator identifying a first user, an evaluation indicator identifying an evaluation of the first content object by the first user, and a context indicator indicating a context associated with the evaluation by the first user, wherein the first content object is one of a plurality of content objects, and, in response to receiving the content evaluation message, storing content evaluation information indicating the first content object, the evaluation, and the context, and indicating the first user as a content curator for the content evaluation information. Accessing content using contextual curated content sequence management may include receiving a request for a sequence of content, wherein the request for the sequence of content includes the context indicator, a curator identifier indicating the content curator, and a user indicator identifying a second user, and, in response to receiving the request for the sequence of content, generating, by a processor in response to instructions stored on a non-transitory computer readable medium, the sequence of content. Generating the sequence of content may include identifying a plurality of curated content objects from the plurality of content objects, wherein each content object from the plurality of curated content objects is associated with a positive evaluation of the respective content object by the content curator for the context, and wherein on a condition that the evaluation identified by the content evaluation message is a positive evaluation, the plurality of curated content objects includes the first content object, and including content objects from the plurality of curated content objects in the sequence of content. Accessing content using contextual curated content sequence management may include transmitting at least one content object from the sequence of content for presentation to the user.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The description herein makes reference to the accompanying drawings wherein like reference numerals refer to like parts throughout the several views, and wherein:

FIG. 1 is a diagram of an example of a communication system for contextual curated content sequence management in accordance with embodiments of this disclosure;

FIG. 2 is a flow diagram of an example of contextual curated content sequence management for digital content access in accordance with embodiments of this disclosure;

FIGS. 3-9 are diagrams of examples of portions of a user interface for contextual curated content sequence management in accordance with embodiments of this disclosure.

### DETAILED DESCRIPTION

A user may access content, such as digital content, via a device, such as a smartphone or a personal computer. Content may be organized and accessed via content sequences, such as stations or playlists. In some embodiments, a content sequence, such as a station, may be generated based on similarity to an identified content object. For example, a music station generated based on an identified song may include other songs similar to the identified song. However, the management and control over content sequences may be limited and inefficient.

In some embodiments, contextual curated content sequence management may improve the management and control over content sequences. Contextual curated content sequence management may include receiving and storing contextual content evaluation information indicating positive evaluations of content, by users of the content, for use in defined contexts, such as activities. For example, the contextual content evaluation information may indicate that a user liked listening to a first song while exercising and liked listening to a second song while relaxing. Contextual curated content sequence management may include generating curated contextual content sequences based on the contextual content evaluation information. In some embodiments, a group of users may generate contextual content evaluation information by evaluating content for use in various contexts, and curated contextual content sequences may be generated based on the contextual content evaluation information for a user following the group, and may include content enjoyed by members of the group in the corresponding context. For example, a user may generate a curated contextual music station for exercising based on a group the user follows, and the curated contextual music station may include songs that members of the group liked to listen to while exercising based on the stored contextual content evaluation information.

The aspects, features, elements, and embodiments of methods, procedures, or algorithms disclosed herein, or any part or parts thereof, may be implemented in a computer program, software, or firmware incorporated in a non-transitory computer-readable storage medium for execution by a computer or processor, such as a special purpose computer or processor, and may be implemented as a computer program product, such as a computer program product accessible from a tangible computer-usable or computer-readable medium.

As used herein, the terminology “computer” or “device” includes any unit, or combination of units, capable of performing any method, or any portion or portions thereof, disclosed herein. Devices may further include mobile devices that may include user equipment, a wireless transmit/receive unit, a mobile station, a fixed or mobile subscriber unit, a pager, a cellular telephone, a personal digital assistant (PDA), a computer, or any other type of user device capable of operating in a mobile environment.

As used herein, the terminology “processor” includes a single processor or multiple processors, such one or more special purpose processors, one or more digital signal processors, one or more microprocessors, one or more controllers, one or more microcontrollers, one or more Application Specific Integrated Circuits (ASICs), one or more Application Specific Standard Products (ASSPs); one or more Field Programmable Gate Arrays (FPGAs) circuits, any other type or combination of integrated circuits (ICs), one or more state machines, or any combination thereof.

As used herein, the terminology “memory” includes any computer-usable or computer-readable medium or device that can, for example, tangibly contain, store, communicate, or transport any signal or information for use by or in connection with any processor. Examples of computer-readable storage mediums may include one or more read only memories, one or more random access memories, one or more registers, one or more cache memories, one or more semiconductor memory devices, one or more magnetic media, such as internal hard disks and removable disks, one or more magneto-optical media, one or more optical media such as CD-ROM disks, and digital versatile disks (DVDs), or any combination thereof.

As used herein, the terminology “example”, “embodiment”, “implementation”, “aspect”, “feature”, or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terminology “digital content” may include computer software programs, video games, music, movies, videos, or any other media that may be embodied in digital form, and which may be accessed, downloaded, input, or otherwise transferred to a computer or processor. Digital content may include digital data or digital files that may be processed by external application programs or may be executed by external software, hardware, or both. As used herein, the terminology “content” may include live content or fixed content. Fixed content may include any content that may be presented from a tangible storage medium, such as digital content. Live content may include any content that may be accessed substantially concurrently with the creation or generation of the content, such as the presentation of a movie in a movie theater, a concert, a sporting event, or any other live event.

As used herein, the terminology “event” may include any presentation, distribution, or display of content capable of concurrent, or nearly concurrent, access by multiple users. For example, an event may include a physical presentation, such a presentation at a movie theater, concert hall, park, venue, museum, or restaurant, or a virtual presentation, such as a broadcast over the Internet or a television broadcast.

As used herein, the terminology “access” or “accessing” may include presenting, downloading, executing, streaming, or otherwise interacting, or enabling interaction, with a digital content object or event. In some embodiments, digital content objects may be executed, stored, or both, at a provider location. In some embodiments, digital content objects may be stored locally on a customer network or customer device and the digital content objects may be executed or run on the customer network or device.

In some embodiments, accessing content using for contextual curated content sequence management may include unit-based licensing. A creator or owner of content, such as digital content, may control access to the content by licensing the content to end users. For example, licensing may include controlling the right to access content, which may include controlling the right to display, perform, distribute, or reproduce the content. Unit-based licensing may include licensing that controls access to content by allocating licensing units to a customer account, such that one or more licensing units may be redeemed or charged to access one or more events or digital content objects. For example, in some embodiments, a content provider may redeem licensing units and provide content in response to a request for access by a customer.

In some embodiments, a node based license may indicate that content is accessible by a unique device, such as a computer, a unique account, such as an account associated with an individual user, or a combination of a unique device and a unique account. In some embodiments, a network based license may indicate that content is accessible by one or more devices within a specified network. For example, a defined number of devices within the network may concurrently access the content. In some embodiments, a license, including a node based license or a network based license, may be associated with a unique content object or event, or with a suite of related content objects and events.

As used herein, the terminology “assigned units”, “price”, “licensing price” or variations thereof, may include an assigned number of licensing units that may be exchanged or redeemed to access a particular event or digital content object. As used herein, the terminology “licensed units” or “allocated units” may refer to a total number of units provided to a customer or customer group. As used herein, the terminology “checked out units”, “redeemed units”, or “exchanged units” may refer to assigned units charged to a customer for events or digital content being accessed. “Available units” may refer to a difference between licensed units and checked out units. In some embodiments, licensing units may be temporarily or permanently exchanged for access. Temporarily exchanged licensing units may be returned to the pool of available units associated with the customer upon termination or completion of content access. Returned units may be included in the available units allocated to the customer and may be redeemed for access to other events or digital content.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

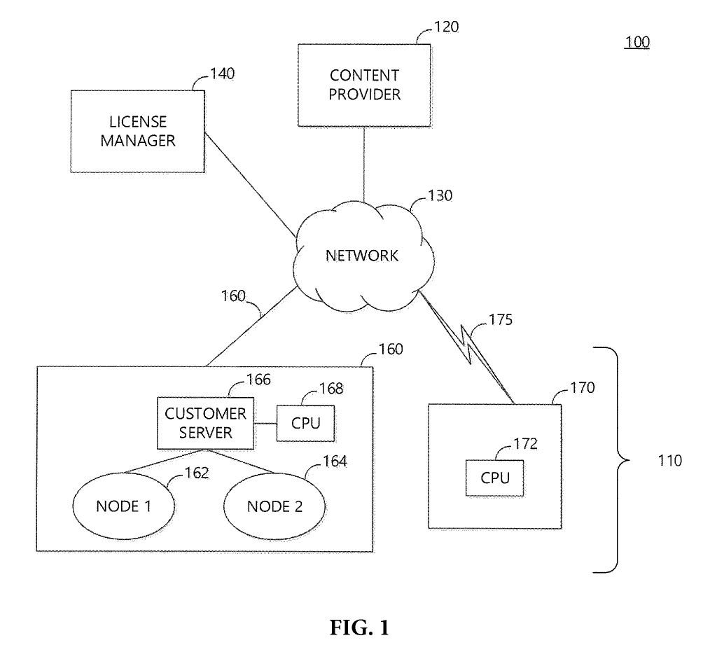

FIG. 1 is a diagram of an example of a communication system 100 for contextual curated content sequence management in accordance with embodiments of this disclosure. For simplicity, the communication system 100 shown in FIG. 1 includes a customer system 110, a provider 120, a network 130, and a license manager 140; however, other elements, such as multiple networks, access points, or communication mediums may be included in a communication system for contextual curated content sequence management.

In some embodiments, customer system 110 may be associated with an individual user or customer, and the user may access events or digital content using licensing units allocated to the user or to an account representing the user. In some embodiments, customer system 110 may comprise devices and networks through which a customer or user may access digital content from provider 120, or register for, or access, events. For example, as shown in FIG. 1, customer system 110 may include a customer network 160 and a customer device 170; however, any number of customer networks and customer devices may be used.

In some implementations, customer system 110 may be associated with a collection or group of customers, or members, and shared licensing units may be allocated to the group. For example, a group may include one or more families, a classroom of students, a small business, a social group, or any other organization capable of licensing events or digital content such that members of the group are capable of accessing the events or digital content.

In some embodiments, elements of the customer system 110, such as customer network 160 and customer device 170, may communicate with each other or with elements external to the customer system 110, such as the provider 120. For example, customer network 160 and customer device 170 may independently communicate through communication network 130.

In some embodiments, customer network 160 may include one or more individual nodes 162/164, a customer server 166, a host processor (CPU) 168, or any combination thereof. A node 162/164 may be a device, such as a computer, and may access digital content. For example, a node 162/164 may access digital content in response to user input. Although FIG. 1 includes a first node 162 and a second node 164 for simplicity, any number of nodes may be used. In some embodiments, a node 162/164 may be connected to a customer server 166 and may have a unique network address. In some embodiments, a node 162/164 may communicate with other nodes 162/164 within customer network 160. The customer server 166 may communicate with CPU 168. Although individual nodes 162/164 are depicted as being connected in a spoke configuration to the customer server 166, the individual nodes 162/164 may be connected in any other electronic computer network configuration. Although shown as separate units, in some embodiments, customer server 166 and CPU 168 may be combined into a single device.

In some embodiments, customer device 170 may be any device, such as a computer or mobile device, capable of accessing digital content. In some embodiments, a customer device 170 may include a processor, such as CPU 172.

In some embodiments, provider 120 may be a device or system configured to provide access to digital content to one or more licensed customers. For example, provider 120 may include an Internet Protocol (IP) network-based unit, such as a website service, that implements methods for controlling access to events or digital content. In some embodiments, provider 120 may provide customer system 110 access to digital content objects, which may be included in a suite of digital content. In some embodiments, provider 120 may be any system configured to control access to or registration for events by licensed customers. Although FIG. 1 shows the provider 120 as a single unit, the provider 120 may include any number of discrete units and any number of providers 120 may be used.

In some embodiments, the provider 120 may include an event provider (not shown separately) and may control access to or registration for one or more events. The event provider may be any system configured to receive a request to access or register for an event and output a response indicating whether access or registration is granted. In some embodiments, the request for access may include a request to register for the event, which may include receiving registration information. In some embodiments, the event provider may be the provider 120. In some embodiments, event provider may be separate from provider 120. Although shown as a single unit in FIG. 1, in some embodiments, the provider 120 may include a content provider as a first unit and the event provider as a second unit. For example, the content provider and the event provider may be independent units within a single physical device, or may be independent physical devices.

In some implementations, contextual curated content sequence management may include communication between the customer system 110 and the provider 120 via the communication network 130. The communication network 130 may be a local area network (LAN), wide area network (WAN), virtual private network (VPN), a mobile or cellular telephone network, the Internet, or any other electronic communication medium. Although not explicitly shown in FIG. 1, each of the customer system 110, provider 120, and license manager 140 may communicate with communication network 130 through one or more Internet service providers (ISPs). In some embodiments, the customer network 160, the customer device 170, or both, may communicate with the network 130 via a wired connection 165 a wireless connection 175, or a combination of one or more wired or wireless connections.

In some embodiments, a license manager (LM) 140 may be included in the communication system 100. License manager 140 may control the access to events, digital content, or both, provided by provider 120. Although shown as a separate unit, in some embodiments, license manager 140 may be incorporated with provider 120, customer system 110, or both. In some embodiments, the license manager 140 may monitor content access for the customer system 110. For example, the license manager 140 may detect the termination or conclusion of access to content.

In some embodiments, license manager 140 may generate and maintain a log. The log may include a record of a number of available units that may be used by the customer system 110 at any given time. In some embodiments, the license manager 140 may update the log for each change of the available units for customer system 110. For example, the log may be updated to indicate a change in the available units in response to the accessing of events or digital content from provider 120, the termination of the access of events or digital content, or a change in pricing of events or digital content being accessed by the customer. In some embodiments, the log may be a file, or database, stored in a memory in communication with provider 120 or license manager 140.

Although not shown in FIG. 1, in some embodiments, communication system 100 may include a registration unit. In some embodiments, a registration unit may be a device, such as a computer. For example, the registration unit may be a kiosk physically located at an event location. In some embodiments, the registration unit may be configured to receive registration information. For example, the registration unit may include a user interface device, such as a keyboard or touchscreen, and may receive user input indicating registration information via the user input device. In some embodiments, the registration unit may communicate with a user device, such as customer device 170.

Although not shown separately in FIG. 1, in some embodiments, a device, such as customer device 170, may access content other than content licensed under unit-based licensing. For example, contextual curated content sequence management may omit unit-based licensing.

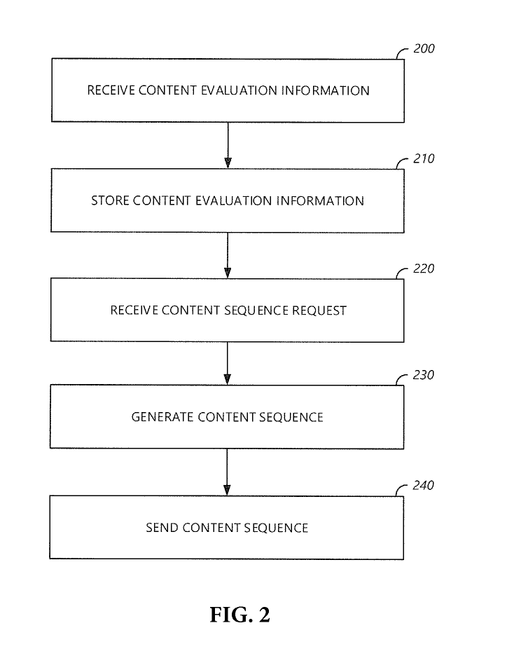

FIG. 2 is a flow diagram of an example of contextual curated content sequence management in accordance with embodiments of this disclosure. In some embodiments, contextual curated content sequence management may be implemented in a device, such as the customer device 170 shown in FIG. 1, which may communicate via a communication system, such as the Internet, or any other wired or wireless computer communication system or network.

In some embodiments, accessing content using contextual curated content sequence management may include receiving a content evaluation message at 200, storing content evaluation information at 210, receiving a content sequence request at 220, generating a content sequence at 230, transmitting the content sequence at 240, or a combination thereof.

In some embodiments, a content evaluation message may be received at 200. In some embodiments, a device, such as the customer device 170, shown in FIG. 1, may receive information indicating an evaluation for a content object within a context from a user of the device. For example, the device may receive input, such as user input, indicating the contextual evaluation information via a user interface presented to the user at the device. In some embodiments, the device may generate a content evaluation message, such as in response to receiving the contextual content evaluation information, and may transmit the content evaluation message to an external device, such as the content provider 120, the license manager 140, or both, shown in FIG. 1, which may receive the message at 200.

In some embodiments, the contextual evaluation information may include a content object indicator, which may uniquely identify a content object, which may be a digital content object, such as a computer software program, a video game, music, a movie, or a video. In some embodiments, the contextual evaluation information may include a user indicator, which may identify the user of the device. In some embodiments, the contextual evaluation information may include a context indicator, which may indicate a context, such as an activity. For example, the context indicator may indicate working, cleaning, cooking, driving, partying, relaxing, studying, exercising, or any other defined context not directly identified by the content, within which the content may be accessed. In some embodiments, the contextual evaluation information may include an evaluation indicator, which may identify an evaluation, such as a positive evaluation, a negative evaluation, a scaled evaluation, or any other quantifiable subjective evaluation of the content object determined by the user for the context. In an example, the content may be music, such as a recording of a song, and the contextual evaluation information may indicate a positive assessment of the music within the context of exercising.

In some embodiments, receiving the content evaluation information at 200 may include receiving content evaluation information indicating ratings for multiple content objects within a context. In some embodiments, receiving the content evaluation information at 200 may include receiving content evaluation information indicating ratings for a content object within multiple contexts. For example, receiving the content evaluation information at 200 may include receiving content evaluation information indicating a positive evaluation for a song within an exercising context, and may include receiving content evaluation information indicating a negative evaluation for the song for use in a relaxing context.

In some embodiments, content evaluation information may be stored at 210. For example, a device, such as the customer device 170 shown in FIG. 1, the content provider 120 shown in FIG. 1, the license manager 140 shown in FIG. 1, or a combination thereof, may store the content evaluation information. In some embodiments, storing the content evaluation information at 210 may include storing, such as in a record, information indicating the contextual evaluation information received at 200, which may include information indicating the evaluation, the content object, the context, or a combination thereof. In some embodiments, storing the content evaluation information at 210 may include storing information indicating a content curator associated with the evaluation. For example, the user indicated by the content evaluation message received at 200 may be identified as the content curator associated with the evaluation. In some embodiments, the content curator may indicate a group or type of user corresponding to the user indicated by the content evaluation message received at 200.

In some embodiments, a content sequence request may be received at 220. In some embodiments, a device, such as the customer device 170, shown in FIG. 1, may receive information indicating a request for a sequence of content from a user of the device. For example, the device may receive input, such as user input, indicating the request for the sequence of content via a user interface presented to the user at the device. In some embodiments, the device may transmit the request for the sequence of content to an external device, such as the content provider 120, the license manager 140, or both, shown in FIG. 1, which may receive the message at 220. The device and user associated with generating the content evaluation information at 200 may be the same device and user as the device and user associated with generating the content sequence request at 220, or may be a different device, a different user, or a different device and a different user.

In some embodiments, the request for the sequence of content may include a context indicator, which may indicate a content type, such as music, movies, images, or any other type of digital content. In some embodiments, the request for the sequence of content may include a context indicator, which may indicate a context. In some embodiments, the request for the sequence of content may include a user indicator identifying the user that initiated the content sequence request. In some embodiments, the request for the sequence of content may include a curator indicator identifying a content curator. In some embodiments, the curator indicator may identify a user, a group of users, a type of users, or a user relationship.

In some embodiments, a content sequence, such as a station or playlist, may be generated at 230. For example, a device, such as the customer device 170 shown in FIG. 1, the content provider 120 shown in FIG. 1, the license manager 140 shown in FIG. 1, or a combination thereof, may generate the content sequence at 230 in response to receiving the content sequence request at 220.

In some embodiments, generating the content sequence at 230 may include identifying one or more content curators based on the content curator identifier indicated in the content sequence request received at 220. For example, the content sequence request may indicate a current user, may indicate a user relationship, such as following, and generating the content sequence at 230 may include identifying users that the current user is following as content creators for the request.

In some embodiments, generating the content sequence at 230 may include identifying available content, such as content available from the content provider or content available for use by the current user.

In some embodiments, generating the content sequence at 230 may include identifying a previously generated content sequence generated based on the content curators for the context and updating the previously generated content sequence to include content based on positive evaluations received subsequent to generating the previously generated content sequence.

In some embodiments, curated content may be identified from the available content. The curated content may be identified based on content evaluation information associated with the content. For example, content evaluation information associated with an available content object may indicate that the content curator indicated by the content sequence request gave the content object a positive evaluation for use in the content indicated by the content sequence request, and the content object may be included in the curated content.

In some embodiments, a content object may be included in the curated content more than once. For example, the content curator indicated by the content sequence request may include multiple users, such as users followed by the user indicated by the content sequence request, content evaluation information associated with the content object may indicate positive evaluations for use in the content from more than one of the content curator users, and the content object may be included in the curated content once for each unique positive evaluation.

In some embodiments, some available content may be omitted from the curated content. For example, evaluation information generated by the content curator for the context may be unavailable for some content. In some embodiments, the available content omitted from the curated content may be identified as candidate content. In some embodiments, content associated with a negative evaluation by the content curator for the context may be omitted from the candidate content. In some embodiments, the candidate content may include content objects from the curated content.

In some embodiments, selected content may be automatically identified from the candidate content based on the curated content. For example, a content object from the candidate content may be similar to a content object from the curated content, and may be included in the selected content. In some embodiments, automatically identifying similar content may include determining a value of a similarity metric for each candidate content object. The value of the similarity metric may indicate a similarity between the candidate content object and one or more of the curated content objects. In some embodiments, a candidate content object that has a similarity metric value that exceeds a similarity threshold may be included in the selected content objects. In some embodiments, a candidate content object that has a similarity metric value that is within, such as less than or equal to, the similarity threshold may be omitted from the selected content objects. In some embodiments, other content may be included in the content sequence. For example, content may be identified and included in the content sequence based on one or more metrics other than the similarity metric, or random content may be included in the content sequence. In some embodiments, including the content in the content sequence may include determining a target ratio, such as sixty percent curated content, for including curated content relative to selected content, and including curated content and selected content based on the target ratio.

In some embodiments, content may be included in the content sequence. In some embodiments, the curated content, or a portion thereof, may be included in the content sequence. In some embodiments, the selected content, or a portion thereof, may be included in the content sequence. In some embodiments, the curated content, or a portion thereof, and the selected content, or a portion thereof, may be included in the content sequence. In some embodiments, the content included in the content sequence may be included in any order, such as a random order, a pseudo-random order, a temporal order based on content creation, a temporal order based on the corresponding positive evaluation, or any other order.

In some embodiments, identifying the curated content, the candidate content, the selected content, or a combination thereof may be omitted. For example, available content may be included in the content sequence, which may include, evaluating each content object, including content for which available content evaluation information indicates a positive evaluation by the content curator for the context, including automatically identified content similar to content for which available content evaluation information indicates a positive evaluation by the content curator for the context, or including a combination of positively rated curated content and automatically identified similar content.

In some embodiments, the content sequence may be transmitted at 240. For example, the content sequence may be generated by a content provider, such as the content provider 120 shown in FIG. 1, at 230 and may be transmitted, such as via a network, such as the network 130 shown in FIG. 1, to the user device that generated and sent the content sequence request received at 220.

In some embodiments, sending the content sequence at 240 may include identifying content from the content sequence, determining a cardinality of assigned units for the content, identifying a cardinality of available licensing units allocated to the user that requested the content sequence, determining that the cardinality of the assigned units is within the cardinality of the available licensing units, and sending the content. In some embodiments, the cardinality of the assigned units may exceed the cardinality of the available licensing units, and sending the content may be omitted.

In some embodiments, a user, a customer, or a group thereof accessing content using a shared pool of allocated licensing units, and the user, or group, may concurrently access multiple content objects. For example, a user may access a first content sequence via a first device and may concurrently access a second content sequence via a second device. In some embodiments, determining the cardinality of assigned units for multiple concurrently accessed content objects may include determining the cardinality of assigned units using stacking, leveling, or a combination thereof, such as weighted leveling.

Stacking may include identifying the cardinality of assigned units as a sum of a cardinality of assigned units for each concurrently accessed content object. For example, a first concurrently accessed content object may have a cardinality of assigned units of five, a second concurrently accessed content object may have a cardinality of assigned units of ten, and the cardinality of assigned units may be identified as 15 (5+10=15).

Leveling may include identifying the cardinality of assigned units as the maximum or peak cardinality of assigned units from among the cardinality of assigned units for each concurrently accessed content object. For example, a first concurrently accessed content object may have a cardinality of assigned units of five, a second concurrently accessed content object may have a cardinality of assigned units of ten, and the cardinality of assigned units may be identified as 10 (MAX[5, 10]=10).

In some embodiments, a combination of leveling licensing and stacking licensing, such as weighted leveling licensing, may be used. Weighted leveling licensing may include identifying a number, or cardinality, of assigned units for concurrently accessing content objects as a weighted average of the cardinality of assigned units for each of the concurrently accessed content object.

In some embodiments, a weight may be identified for weighted leveling licensing. For example, a first content object may have a cardinality of assigned units of five, a second concurrently accessed content object may have a cardinality of assigned units of ten, a weighted leveling licensing weight, such as eighty percent, may be identified, and the cardinality of assigned units may be identified based on the cardinality of assigned units for the first content object, the cardinality of assigned units for the second content object, and the weight, as 12 (0.8(5+10)=12).

In some embodiments, a weight may be identified for each concurrently accessed content object. For example, a first content object may have a cardinality of assigned units of five and a weight of eighty percent, a second concurrently accessed content object may have a cardinality of assigned units of ten and a weight of eighty percent, and the cardinality of assigned units may be identified as a sum of the weighted cardinality for the first content object and the weighted cardinality for the second content object, as 12 (0.8(5)+0.8(10)=12).

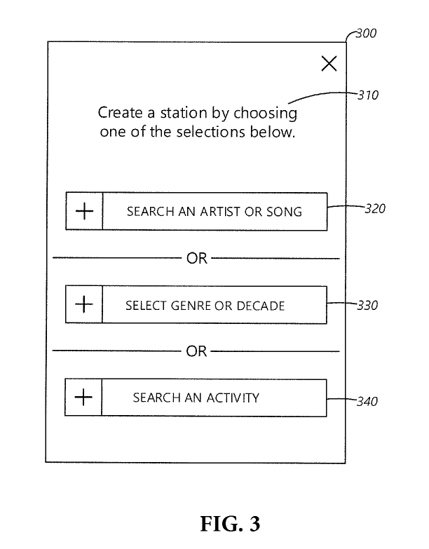

FIGS. 3-9 are diagrams of examples of portions of a user interface for contextual curated content sequence management, as shown in FIG. 2, in accordance with embodiments of this disclosure.

FIG. 3 shows an example of a user interface 300 for initiating the generation of a content sequence request. As shown, the user interface 300 for initiating the generation of a content sequence request includes a descriptive portion 310, which describes the features and functions of the user interface 300 for initiating the generation of a content sequence request, and one or more controls 320/330/340. In some embodiments, the generation of a content sequence request may be initiated in response to input, such as user input, selecting the ‘Search an Activity’ control 340.

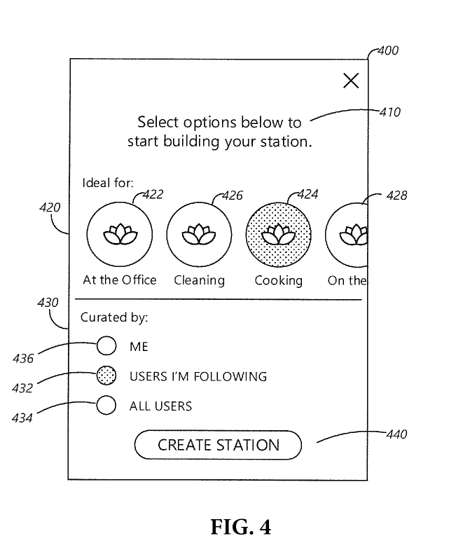

FIG. 4 shows an example of a user interface 400 for controlling the generation of a content sequence request. As shown, the user interface 400 for controlling the generation of a content sequence request includes a descriptive portion 410, which describes the features and functions of the user interface 400 for controlling the generation of a content sequence request, a context control portion 420, a content curator control portion 430, and a content sequence request generation control 440.

The context control portion 420 includes context indication controls 422/424/426/428. In some embodiments, a context indication control 422/424/426/428 may be identified in response to input, such as user input, selecting the respective context indication control 422/424/426/428. In some embodiments, a selected context indication control may be visually differentiated from unselected context indication controls. For example, the ‘Cooking’ context indication control 424 is shown with a stippled background to indicated that it is a selected context indication control. Although not expressly shown in FIG. 4, in some embodiments, multiple context indication controls may be identified.

In some embodiments, one or more of the context indication controls 422/424/426/428 currently included in the context control portion 420 may be omitted from the context control portion 420 and one or more additional context indication controls (not shown) may be included in the context control portion 420. For example, the context indication controls included in the context control portion 420 may change in response to input, such as user input, scrolling, swiping, or dragging horizontally across the context control portion 420.

The content curator control portion 430 includes content curator controls 432/434/436. In some embodiments, a content curator control 432/434/436 may be identified in response to input, such as user input, selecting a content curator control 432/434/436. In some embodiments, a selected content curator control may be visually differentiated from unselected content curator controls. For example, the ‘Users I'm Following’ content curator control 432 is shown with a stippled background to indicate that it is a selected content curator control. Although not expressly shown in FIG. 4, in some embodiments, multiple content curators may be identified.

In some embodiments, the content sequence request generation control 440 may be inactive, such as greyed out, until a context and a curator are selected. In some embodiments, a curated content sequence may be generated as shown in FIG. 2 in response to input, such as user input, selecting the content sequence request generation control 440.

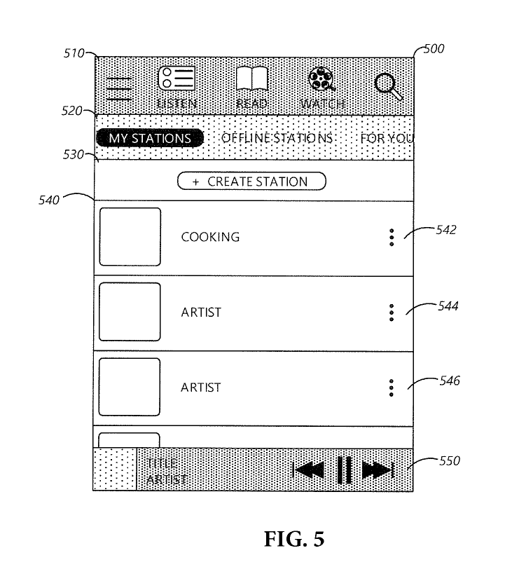

FIG. 5 shows an example of a user interface 500 for listing content sequences. As shown, the user interface 500 for listing content sequences includes a system control portion 510, which includes system controls, content sequence control portions 520/530, which includes controls for viewing and managing content sequences, a content sequence list portion 540, which includes content sequence portions 542/544/546, and a content control portion 550, which includes controls for controlling active content. The content sequence, or station, requested using the user interface 400 shown in FIG. 4, and generated as shown in FIG. 2, may be represented by the content sequence portion 542 at the top of the content sequence list portion 540. In response to receiving the content sequence sent as shown at 240 in FIG. 2, the first content object in the content sequence may be automatically presented to the user, and the presentation thereof may be controlled by the content control portion 550.

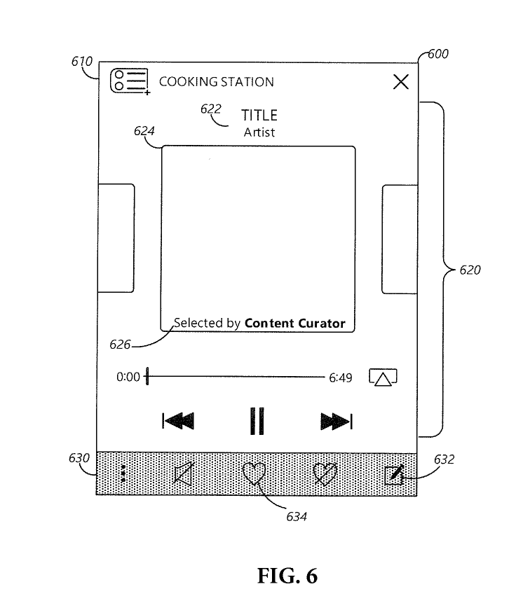

FIG. 6 shows an example of a user interface 600 for managing a content sequence. As shown, the user interface 600 for managing a content sequence includes a header portion 610, which includes a description of the current content sequence, a content control portion 620, and a content sequence control portion 630. The content control portion 620 includes a description, including a title and artist, or author, for the currently active content object. The content control portion 620 includes a pictographic representation 624 of the current active content object, such as album art.

The content control portion 620 includes a curator portion 626, which indicates the content curator that positively reviewed the currently active content object for the currently active context. The curator portion 626 may include a name of the content curator, as indicated by the bold text ‘Content Curator’. In some implementations, the curator portion 626 may be superimposed on the pictographic representation 624 of the current active content object. In some implementations, information regarding the content curator, such as profile information, may be presented in response to input, such as user input, selecting the content curator portion 626. In some implementations, the curator portion 626 may be omitted. For example, the currently active content may be curated by the user that requested the content sequence, and the curator portion 626 may be omitted.

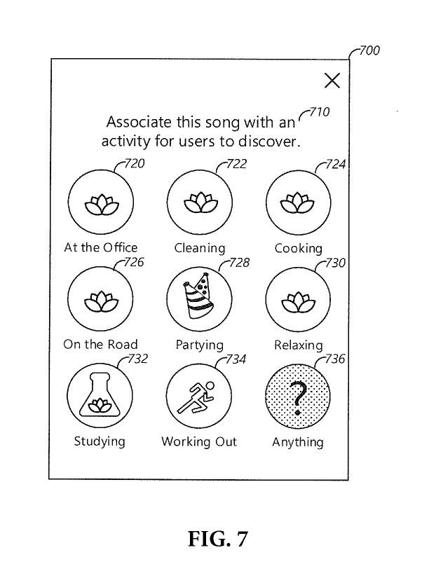

The content sequence control portion 630 includes controls, such as the edit content sequence control 632 and the positive evaluation control 634. In some embodiments, an edit content sequence user interface may be presented in response to input, such as user input, selecting the edit content sequence control 632. The edit content sequence user interface may be similar to the user interface 400 for controlling the generation of a content sequence request shown in FIG. 4, except that context and curator for the current content sequence may be automatically selected. In some embodiments, a content evaluation user interface, such as the content evaluation user interface shown in FIG. 7, may be presented in response to input, such as user input, selecting the positive content evaluation control 634.

FIG. 7 shows an example of a user interface 700 for reviewing content. As shown, the user interface 700 for reviewing content includes a descriptive portion 710, which describes the features and functions of the user interface 700, and context indication controls 720-736. As shown, the context indication controls 720-736 include a working context indication control 720 representing an activity related to working and labeled ‘At the Office’, a cleaning context indication control 722 representing an activity related to cleaning, a cooking context indication control 724 representing an activity related to cooking, a driving context indication control 726 representing an activity related to traveling and labeled ‘On the Road’, a partying context indication control 728 representing an activity related to partying, a relaxing context indication control 730 representing an activity related to relaxing, a studying context indication control 732 representing an activity related to studying, an exercising context indication control 734 representing an activity related to exercising and labeled ‘Working Out’, and an anything control 736 representing activities other than the activities represented by the other context controls 720-734.

In some embodiments, a context indication control 720-736 may be selected. For example, the anything control 736 may be automatically selected. In another example, a context indication control 720-736 may be selected in response to input, such as user input, selecting the context indication control 720-736.

In some embodiments, a message or signal indicating an evaluation and a selected context for the current content object may be generated and sent, and may be received as shown at 200 in FIG. 2. For example, the content evaluation information may be sent in response to input, such as user input, selecting the context indication control 720-736. In some embodiments, the content evaluation information may be sent in response to the expiration of a timer. For example, a timer may be initiated in response to presenting the user interface 700 for reviewing content, the expiration of the timer may be identified after a defined time period, such as two or three seconds, and the content evaluation information may be sent in response to the expiration of the timer. In some embodiments, presentation of the user interface 700 for reviewing content may be omitted or terminated in response to input, such as user input, selecting the context indication control 720-736, or in response to expiration of the timer. In some implementations, the user interface 700 for reviewing content may be presented superimposed over another user interface, such as the user interface 600 shown in FIG. 6.

Although FIG. 7 shows nine activities, or contexts, 720-736, any number of contexts may be used. In some embodiments, a context may be a system defined context. In some embodiments, a context may be a user defined context. For example, a context may be identified in response to input, such as user input, indicating a name, a description, or any other defining information for the context.

Although not shown in FIG. 7, in some embodiments, the user interface 700 for reviewing content may include a suppression control and presentation of the user interface 700 for reviewing content may be omitted in response to previously recorded input, such as user input, selecting the suppression control for the user interface 700 for reviewing content, and the anything context may be automatically selected.

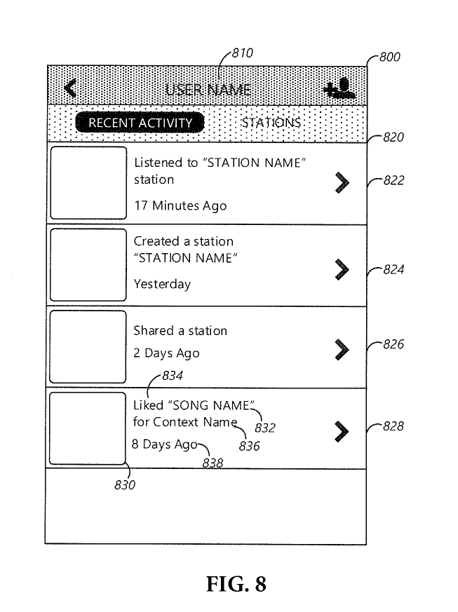

FIG. 8 shows an example of a user interface 800 for viewing recent actions of a user, such as the recent actions of a user, or content curator, other than the current user. As shown, the user interface 800 for viewing recent actions includes header portion including a name of the user, or content curator, associated with the recent actions, and a recent actions list portion 820. The recent actions list portion 820 includes a list of recent action portions 822/824/826/828. Each recent action portion 822/824/826/828 represents a recent action performed by the user, or content curator, for a content object, and includes information representing the recent action. For example, the recent action portion 828 shown at the bottom represents the generation of content evaluation information for a content object by the user, or content curator, and includes album art 830 for the content object, a title 832 for the content object, a description 834 of the action, a name of the context 836 of the action, and a temporal indicator 838, which may include a time, a date, or both, for the action. In some embodiments, a user interface for managing a content sequence, such as the a user interface 600 for managing a content sequence shown in FIG. 6, may be presented in response to input, such as user input, selecting a recent action portion associated with a context, such as the bottom recent action portion 828.

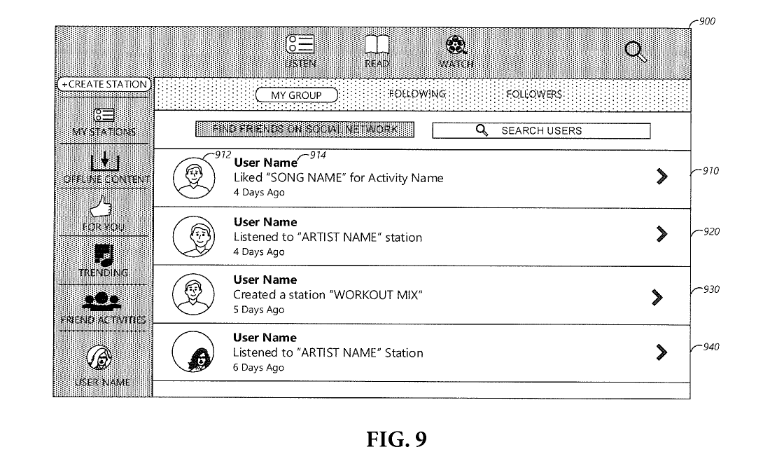

FIG. 9 shows an example of a user interface 900 for viewing recent actions of users or content creators. The user interface 900 for viewing recent actions of users or content creators may be similar to the user interface 800 for viewing recent actions of a user or content creator shown in FIG. 8 except as shown and described. As shown in FIG. 9, each recent action portion 910/920/930/940 may be associated with a respective user, or content curator, and a respective action, and may include a pictographic representation 912 of the corresponding user, or content creator, such as an avatar or an icon, and a name 914 of the corresponding user, or content creator.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method comprising:
receiving a request for a sequence of content, wherein the request for the sequence of content includes a context indicator identifying a context, a curator indicator identifying a content curator, and a user indicator identifying a user;
generating, by a processor in response to instructions stored on a non-transitory computer readable medium, the sequence of content, wherein generating the sequence of content includes:
identifying a plurality of content objects, and
including content objects from the plurality of content objects in the sequence of content based on the context and the content curator; and
transmitting at least one content object from the sequence of content for presentation to the user.

2. The method of claim 1, wherein including content objects in the sequence of content includes:
for each content object from the plurality of content objects:
on a condition that the content object is associated with an evaluation of the content object by the content curator for the context:
on a condition that the evaluation is a positive evaluation, including the content object in the sequence of content; and
on a condition that the evaluation is a negative evaluation, omitting the content object from the sequence of content.

3. The method of claim 1, wherein including content objects in the sequence of content includes:
identifying a plurality of curated content objects from the plurality of content objects, wherein each content object from the plurality of curated content objects is associated with a positive evaluation of the respective content object by the content curator for the context;
identifying a plurality of candidate content objects from the plurality of content objects such that the plurality of candidate content objects omits content objects from the plurality of curated content objects;
identifying a plurality of selected content objects from the plurality of candidate content objects wherein each content object from the plurality of selected content objects is similar to a content object from the plurality of curated content objects; and
including the plurality of selected content objects in the sequence of content.

4. The method of claim 3, wherein identifying the plurality of selected content objects from the plurality of candidate content objects includes:
for each content object from the plurality of candidate content objects:
determining a similarity metric value for the content object based on the content object and the plurality of curated content objects;
on a condition that the similarity metric value exceeds a similarity threshold, including the content object in the plurality of selected content objects; and
on a condition that the similarity metric value is within the similarity threshold, omitting the content object from the plurality of selected content objects.

5. The method of claim 3, wherein including content objects in the sequence of content includes:
including the plurality of curated content objects in the sequence of content.

6. The method of claim 1, wherein the context is an activity.

7. The method of claim 6, wherein the activity is working, cleaning, cooking, driving, partying, relaxing, studying, or exercising.

8. The method of claim 1, wherein the context includes a plurality of activities.

9. The method of claim 1, wherein the content curator is the user, an identified user other than the user, a user from a plurality of users identified by the user, or a user from a plurality of users associated with an organization.

10. The method of claim 1, further comprising:
receiving a content evaluation message, the content evaluation message including a content object indicator identifying a content object from the plurality of content objects, the user indicator, an evaluation indicator identifying an evaluation of the content object by the user, and a context indicator indicating a context associated with the evaluation by the user; and
storing content evaluation information indicating the evaluation, the content object, and the context, and indicating the user as a content curator for the evaluation.

11. A method comprising:
receiving a request for a sequence of content, wherein the request for the sequence of content includes a context indicator identifying a context, a curator indicator identifying a content curator, and a user indicator identifying a user;
generating, by a processor in response to instructions stored on a non-transitory computer readable medium, the sequence of content, wherein generating the sequence of content includes:
identifying a plurality of content objects,
identifying a plurality of curated content objects from the plurality of content objects, wherein each content object from the plurality of curated content objects is associated with a positive evaluation of the respective content object by the content curator for the context, and
including content objects from the plurality of curated content objects in the sequence of content; and
transmitting at least one content object from the sequence of content for presentation to the user.

12. The method of claim 11, wherein including content objects in the sequence of content includes:
identifying a plurality of candidate content objects from the plurality of content objects such that the plurality of candidate content objects omits content object from the plurality of curated content objects;
identifying a plurality of selected content objects from the plurality of candidate content objects wherein each content object from the plurality of selected content objects is similar to a content object from the plurality of curated content objects; and
including the plurality of selected content objects in the sequence of content.

13. The method of claim 12, wherein identifying the plurality of selected content objects from the plurality of candidate content objects includes:
for each content object from the plurality of candidate content objects:
determining a similarity metric value for the content object based on the content object and the plurality of curated content objects;
on a condition that the similarity metric value exceeds a similarity threshold, including the content object in the plurality of selected content objects; and
on a condition that the similarity metric value is within the similarity threshold, omitting the content object from the plurality of selected content objects.

14. The method of claim 11, wherein the context is an activity.

15. The method of claim 14, wherein the activity is working, cleaning, cooking, driving, partying, relaxing, studying, or exercising.

16. The method of claim 11, wherein the content curator is the user, an identified user other than the user, a user from a plurality of users identified by the user, or a user from a plurality of users associated with an organization.

17. The method of claim 11, further comprising:
receiving a content evaluation message, the content evaluation message including a content object indicator identifying a content object from the plurality of content objects, the user indicator, an evaluation indicator identifying an evaluation of the content object by the user, and a context indicator indicating a context associated with the evaluation by the user; and
storing content evaluation information indicating the evaluation, the content object, and the context, and indicating the user as a content curator for the evaluation.

18. A method comprising:
receiving a content evaluation message, the content evaluation message including a content object indicator identifying a first content object, a user indicator identifying a first user, an evaluation indicator identifying an evaluation of the first content object by the first user, and a context indicator indicating a context associated with the evaluation by the first user, wherein the first content object is one of a plurality of content objects;
in response to receiving the content evaluation message, storing content evaluation information indicating the first content object, the evaluation, and the context, and indicating the first user as a content curator for the content evaluation information;
receiving a request for a sequence of content, wherein the request for the sequence of content includes the context indicator, a curator identifier indicating the content curator, and a user indicator identifying a second user;
in response to receiving the request for the sequence of content, generating, by a processor in response to instructions stored on a non-transitory computer readable medium, the sequence of content, wherein generating the sequence of content includes:
identifying a plurality of curated content objects from the plurality of content objects, wherein each content object from the plurality of curated content objects is associated with a positive evaluation of the respective content object by the content curator for the context, and wherein on a condition that the evaluation identified by the content evaluation message is a positive evaluation, the plurality of curated content objects includes the first content object, and
including content objects from the plurality of curated content objects in the sequence of content; and
transmitting at least one content object from the sequence of content for presentation to the user.

19. The method of claim 18, wherein including content objects in the sequence of content includes:
identifying a plurality of candidate content objects from the plurality of content objects such that the plurality of candidate content objects omits content object from the plurality of curated content objects;
identifying a plurality of selected content objects from the plurality of candidate content objects wherein each content object from the plurality of selected content objects is similar to a content object from the plurality of curated content objects; and
including the plurality of selected content objects in the sequence of content.

20. The method of claim 19, wherein identifying the plurality of selected content objects from the plurality of candidate content objects includes:
for each content object from the plurality of candidate content objects:
determining a similarity metric value for the content object based on the content object and the plurality of curated content objects;
on a condition that the similarity metric value exceeds a similarity threshold, including the content object in the plurality of selected content objects; and
on a condition that the similarity metric value is within the similarity threshold, omitting the content object from the plurality of selected content objects.
